(19) United States
(12) Patent Application Publication
(10) Pub. No.: US 2022/0068151 A1
(43) Pub. Date: Mar. 3, 2022

(54) RELAY SERVER FOR ONE-TO-MANY MATCHED LANGUAGE LEARNING AND METHOD FOR TEACHING A LANGUAGE

(71) Applicant: HayanMind Inc., Daejeon (KR)

(72) Inventor: Jeung Min OH, Daejeon (KR)

(73) Assignee: Hayanmind Inc., Daejeon (KR)

(21) Appl. No.: 17/421,198

(22) PCT Filed: Dec. 7, 2020
(86) PCT No.: PCT/KR2020/017793

§ 371 Date: Jul. 7, 2021

(30) Foreign Application Priority Data
Dec. 6, 2019 (KR) 10-2019-0161214
Dec. 6, 2019 (KR) 10-2019-0161215
Dec. 6, 2019 (KR) 10-2019-0161216
Dec. 7, 2020 (KR) 10-2020-0169682

(51) Int. Cl. G09B 5/14; G09B 19/00

(52) U.S. Cl. CPC G09B 5/14; G09B 19/00

(57) ABSTRACT

The present disclosure relates to a technology for providing one-to-many matched language learning between a language instructor and students by using online messages, where, based on the observation that questions and answers are made speedily by the native-speaking instructor whereas questions and answers are made comparatively slowly by the students who are not fluent in the foreign language, a single language instructor leaves lesson channels open for a multiple number of students simultaneously so as to utilize the limited teaching time as efficiently as possible by wasting no time and interacting with another student while a particular student prepares a question or an answer.

### BACKGROUND

### 1. Technical Field

The present disclosure relates to a technology for providing one-to-many matched language learning between a language instructor and students by using online messages, where, based on the observation that questions and answers are made speedily by the native-speaking instructor whereas questions and answers are made comparatively slowly by the students who are not fluent in the foreign language, a single language instructor leaves lesson channels open for a multiple number of students simultaneously so as to utilize the limited teaching time as efficiently as possible by wasting no time and interacting with another student while a particular student prepares a question or an answer.

### 2. Description of the Related Art

With increased interactions with foreign countries in the fields of economy, culture, sports, and the like, there is a growing emphasis placed on the ability to speak foreign languages. However, grammar-oriented language education in schools has left students and office workers alike capable of reading foreign literature but incompetent in exchanging simple conversations with foreign nationals.

As interactions with foreign countries increase in frequency, there is a growing demand for persons conversant in foreign languages, and students and office workers are learning conversational language skills using various methods such as attending classes, taking telephone courses, taking online courses, etc.

However, although the most important part of language learning is to talk a lot in the language to naturally become familiar with the language, most students learning a language, such as English for example, tend to experience anxiety in situations involving a 1:1 real-time conversation with a native-speaking instructor.

Also, as English learners find it difficult to converse immediately and tend to first construct a sentence internally, a student would often talk much more slowly than native speakers, and the native-speaking instructor would waste time waiting for the student.

In addition, in language lessons received in real time, it is impossible to replay a conversation, and the resources of the native speaker would be wasted due to a student or students repeatedly asking what the speaker said, whereby the learning experience would lose its effectiveness, and students would stop the language learning course midway.

### SUMMARY OF THE INVENTION

An aspect of the present disclosure, which was derived to resolve the problems described above, is based on the observation that the speed of the response of a student is typically slower than the speed of the questioning by the native-speaking language instructor. Thus, an objective of the present disclosure is to provide a relay server for one-to-many matched language learning that can minimize occurrences of wasted time by allowing the language instructor and the students to proceed with a lesson by way of exchanging recorded messages and thus overcoming the differences in conversation speed between the language instructor and the students.

Another objective of the present disclosure is to provide a relay server for one-to-many matched language learning that connects one language instructor with a multiple number of students within the same time segment and allows the language instructor to provide a question to a second student while waiting for an answer from a first student, so as to reduce time waste from delays caused by the language instructor having to wait for an answer from a student.

Also, still another objective of the present disclosure is to provide a relay server for one-to-many matched language learning that can fully utilize the lesson time by allowing a user to make an inquiry to an assistant instructor connected online before making a recording when the user cannot think of a particular word or expression during the process of recording a voice message for exchanging between the language instructor and the student.

Other objectives of the present disclosure will be more clearly understood from the embodiments set forth below.

A relay server for one-to-many matched language learning that connects one language instructor with a multiple number of students according to an aspect of the present disclosure includes: a matching generator configured to generate lesson rooms for connecting a multiple number of students and a language instructor and generate a lesson channel between each of the students and the language instructor who have accessed the lesson rooms; and a matching manager configured to set an order of priority according to a predetermined rule for student's voice messages that have arrived at the lesson rooms and sequentially activate the lesson channels of the messages according to the set order of priority, when a lesson begins.

The matching manager can assign the order of priority by using at least one of an order in which the student's voice messages arrived at the lesson rooms, the replay times of the student's voice messages, the wait times of the student's voice messages in the lesson rooms, and the average replying times of the students or instructor.

A message editor can further be included, which may be configured to analyze a student's voice message that has arrived at a lesson room to identify a silent segment and delete the identified silent segment from the analyzed student's voice message, in which case the matching manager can assign priority to student's voice messages that have passed through the message editor.

A repetitive learning unit can further be included, which may, upon request by a student, provide a repetition of a requested instructor's voice message to the student who made the request.

A side learning unit can further be included, which may be configured to provide a list of available assistant instructors to a student and generate an inquiry channel, upon request by the student, between the student and an assistant instructor for making an inquiry in a native language of the student.

An instructor list generator can further be included, which may be configured to generate a list of valid instructors available for enrollment, based on the teaching schedules of the language instructors, the enrollment requests of students, and the number of messages per time for each language instructor, and provide the list of valid instructors to students.

The instructor list generator can display previously matched instructors, who have a history of a previous match with the student, or similarly matched instructors, who have lesson patterns similar to that of a previously matched instructor, in a manner differentiated from other instructors in the list.

Another aspect of the present disclosure proposes a method for one-to-many matched language teaching performed at a language instructor terminal, where the method includes: a displaying by a display module of a multiple number of students; a generating by a channel module of a lesson channel with each of the multiple students in a P2P (peer-to-peer) manner; a setting by an order module of an order of priority for student's voice messages according to a predetermined rule, when the student's voice messages arrive at the language instructor terminal through the generated lesson channels; and a sequential activating by an automatic matching module of the lesson channels of the student's voice messages according to the set order of priority.

In one example, the setting of the order of priority can include assigning the order of priority by using at least one of the orders in which the student's voice messages arrived at the language instructor terminal, the replay times of the student's voice messages, wait times of the student's voice messages at the language instructor terminal, and average replying times of the students or instructor.

The method can further include the operations of analyzing a student's voice message that has arrived at the language instructor terminal to identify a silent segment and deleting the identified silent segment from the analyzed student's voice message, in which case the setting of the order of priority can include assigning priority to student's voice messages from which the silent segments have been deleted.

The method can further include an operation of providing a student with a repetition of a requested instructor's voice message when the student makes such a request.

A relay server for one-to-many matched language learning according to an embodiment of the present disclosure provides the following advantageous effects.

Based on the observation that the speed of the response of a student is typically slower than the speed of the questioning by the native-speaking language instructor, an embodiment of the present disclosure allows the language instructor and the students to proceed with a lesson by way of exchanging recorded messages, to thus overcome the differences in conversation speed between the language instructor and the students and minimize occurrences of time waste in the lesson.

An embodiment of the present disclosure connects one language instructor with a multiple number of students within the same time segment and allows the language instructor to provide a question to a second student while waiting for an answer from a first student, so as to reduce time waste from delays caused by the language instructor having to wait for an answer from a student.

An embodiment of the present disclosure makes it possible to fully utilize the lesson time by allowing a user to make an inquiry to an assistant instructor connected online before making a recording, when the user cannot think of a particular word or expression during the recording of a voice message for exchanging between the language instructor and the student.

The advantageous effects of the present disclosure are not limited to those mentioned above, and other effects that are not specifically mentioned herein would be apparent to the skilled person from the disclosure provided below.

### BRIEF DESCRIPTION OF THE DRAWINGS

FIG. 1 is a schematic diagram illustrating a relay server for one-to-many matched language learning according to an embodiment of the present disclosure.

FIG. 2 is a block diagram illustrating a relay server for one-to-many matched language learning according to an embodiment of the present disclosure.

FIG. 3 is a diagram illustrating the interfaces at terminals for relaying student's voice messages and instructor's voice messages from a lesson room generated at a relay server for one-to-many matched language learning according to an embodiment of the present disclosure.

FIG. 4 is a diagram illustrating a queue of student's voice messages passing through a relay server for one-to-many matched language learning according to an embodiment of the present disclosure.

FIG. 5 is a diagram illustrating a dynamic matching between language instructors and students at a relay server for one-to-many matched language learning according to an embodiment of the present disclosure.

FIG. 6 is a flow diagram illustrating a method for one-to-many matched language teaching according to an embodiment of the present disclosure.

FIG. 7 is a diagram of a language instructor terminal for implementing a method for one-to-many matched language teaching according to another embodiment of the present disclosure.

### DETAILED DESCRIPTION OF THE INVENTION

### 1. Best Mode

As the present disclosure allows for various changes and numerous embodiments, particular embodiments will be illustrated in the drawings and described in detail in the written description. However, this is not intended to limit the present disclosure to particular modes of practice, and it is to be appreciated that all changes, equivalents, and substitutes that do not depart from the spirit and technical scope of the present disclosure are encompassed by the present disclosure. In the description of the present disclosure, certain detailed explanations of the related art are omitted if it is deemed that they may unnecessarily obscure the essence of the present disclosure.

The terms used in the present specification are merely used to describe particular embodiments and are not intended to limit the present disclosure. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

While such terms as “first” and “second,” etc., can be used to describe various components, such components are not to be limited by the above terms. The above terms are used only to distinguish one component from another.

Certain embodiments of the present disclosure will be described below in more detail with reference to the accompanying drawings. Those components that are the same or are in correspondence are rendered the same reference numeral, and redundant descriptions are omitted.

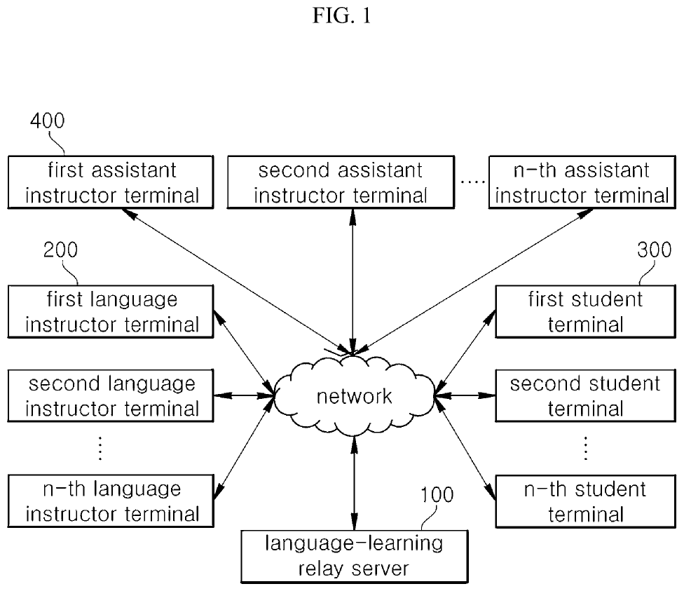

A detailed description is provided below, with reference to FIGS. 1 to 5, of a relay server for one-to-many matched language learning according to certain embodiments of the present disclosure.

FIG. 1 is a schematic diagram illustrating a relay server for one-to-many matched language learning according to an embodiment of the present disclosure.

As illustrated in FIG. 1, a relay server for one-to-many matched language learning according to an embodiment of the present disclosure is composed of a language-learning relay server 100, a multiple number of language instructor terminals such as a first language instructor terminal 200, a second language instructor terminal 200, etc., a multiple number of student terminals such as a first student terminal 300, a second student terminal 300, etc., and a multiple number of assistant instructor terminals such as a first assistant instructor terminal 400, a second assistant instructor terminal 400, etc.

The language-learning relay server 100, the multiple language instructor terminals 200, the multiple student terminals 300, and the multiple assistant instructor terminals 400 are connected over a communication network such as a mobile communication network, the Internet, the PNTN (Professional National Title Network), etc.

The language-learning relay server 100, which serves to connect one language instructor with multiple students in real time, can generate a lesson room for connecting a language instructor terminal 200 with a student terminals 300 over an application installed on the language instructor terminal 200 and an application installed on the student terminal 300 and relay the student's voice messages and instructor's voice messages exchanged within the lesson room.

Upon receiving a side inquiry request from a language instructor terminal 200 or a student terminal 300, the language-learning relay server 100 can connect an assistant instructor terminal 400 to a lesson channel generated in the corresponding lesson room.

The language-learning relay server 100 can include a membership database that manages basic information regarding the language instructors associated with the language instructor terminals 200, students associated with the student terminals 300, and assistant instructors associated with the assistant instructor terminals 400. For example, the basic information can include the name, address, contact, gender, age, enrollment history, teaching history, etc., of each member.

A language instructor terminal 200 is a device owned by an instructor teaching the language course and can be installed with an application for teaching the language. A single language instructor terminal 200 can be connected to multiple student terminals 300 and can exchange student's voice messages and instructor's voice messages with the corresponding student terminals 300 through lesson rooms connected respectively with the multiple student terminals 300.

In one embodiment, the language instructor terminal 200 can calculate the charge for the teaching based on the duration of the teaching, the number of corresponding students, the duration of the instructor's voice message recordings, the number of instructor's voice message transmissions, etc., the details of which are omitted here.

A student terminal 300 is a device used by a student enrolled in the language lesson and can be installed with an application for enrollment. A multiple number of student terminals 300 can be connected to a single language instructor terminal 200, and each can have a lesson room connected with the language instructor terminal 200 to exchange student's voice messages and instructor's voice messages with the language instructor terminal 200 through the lesson room.

In one embodiment, the student terminal 300 can calculate the fee for the enrollment based on the duration of the lesson, the duration of the student's voice message recordings, the number of student's voice message transmissions, the duration of the instructor's voice message recordings, the number of instructor's voice message transmissions, etc., the details of which are omitted here.

An assistant instructor terminal 400 is a device owned by an assistant instructor that addresses side inquiries regarding the foreign language between a language instructor and a student and can be connected to each of a multiple number of language instructor terminals 200 and a multiple number of student terminals 300 through a lesson room. The assistant instructor terminal 400 can be connected to language instructor terminals 200 or student terminals 300 according to the language in which the assistant instructor is capable of addressing side inquiries.

In one embodiment, the assistant instructor terminal 400 can calculate the charge for the side inquiries based on the number of words inquired, the number of sentences inquired, etc., the details of which are omitted here.

The language instructor terminals 200, student terminals 300, and assistant instructor terminals 400 can correspond to computing devices such as PC's (personal computers), smart phones, PDA's (personal digital assistants), and tablet PC's that are equipped with central processing units, memory devices, and input/output means.

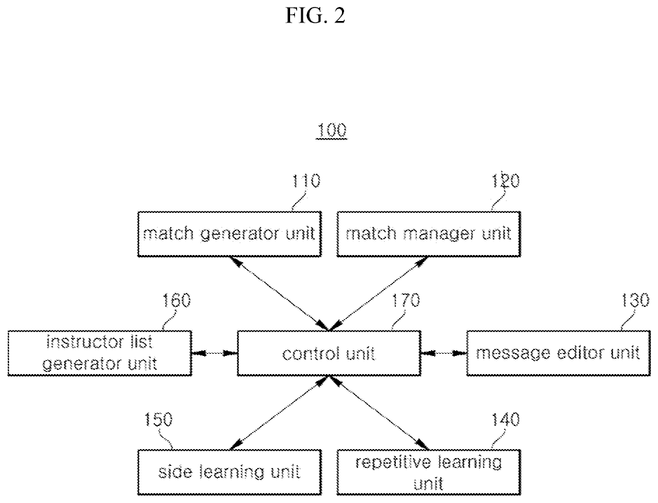

FIG. 2 is a block diagram illustrating a relay server for one-to-many matched language learning according to an embodiment of the present disclosure.

As illustrated in FIG. 2, a relay server 100 for one-to-many matched language learning according to an embodiment of the present disclosure includes a matching generator 110 and a matching manager 120.

Also, the relay server 100 for one-to-many matched language learning can further include at least one of a message editor 130, a repetitive learning unit 140, a side learning unit 150, an instructor list generator 160, and a controller 170.

The matching generator 110 can generate lesson rooms for connecting multiple students with a language instructor. The matching generator 110 can generate a lesson room when a language instructor is selected by a student from a list of valid instructors provided through the instructor list generator 160 described later on. The lesson room is generated at each of the language instructor terminal 200 and the student terminal 300 and is activated, according to whether or not a lesson channel is generated, to connect the student with the language instructor and allow an exchanging of voice messages.

The matching generator 110 generates one lesson room for a student and multiple lesson rooms for a language instructor so as to form a one-to-many matching between the language instructor and the students.

The matching generator 110 can generate a lesson channel according to student's voice messages and instructor's voice messages exchanged between the students and the language instructor who have accessed a lesson room. The lesson channel can be generated in correspondence to each student's voice message and instructor's voice message and can be generated to transmit the student's voice message and instructor's voice message from the lesson room.

Once a lesson is started between the students and the language instructor, the matching manager 120 can set an order of priority, according to a predetermined rule, for the student's voice messages that have arrived at the lesson rooms and can activate the lesson channels sequentially according to the order of priority. Here, it is assumed that multiple lesson rooms are generated with respect to a single language instructor.

When an instructor's voice message arrives at a lesson room generated in a student terminal 300, the matching manager 120 can activate a lesson channel, and when student's voice messages arrive at the lesson rooms generated in a language instructor terminal 200, the matching manager 120 can assign an order of priority by using at least one of the order of arrival, the replay times of the student's voice messages, the wait times of the student's voice messages in the lesson rooms, and the average replying times of the students or instructor.

In one embodiment, the matching manager 120 can assign priority based on the order in which the starting points of the student's voice messages have arrived. For example, if a first student terminal 300 transmits a first student's voice message at the first time and a second student terminal 300 transmits a second student's voice message at a second time that is later than the first time, then the first student's voice message would arrive at the lesson room before the second student's voice message, and thus the matching manager 120 can assign a higher priority to the first student's voice message transmitted from the first student terminal 300 than to the second student's voice message transmitted from the second student terminal 300.

In another embodiment, the matching manager 120 can assign priority based on the order in which the ending points of the student's voice messages have arrived, i.e., the order in which the student's voice messages were completed. For example, if a first student terminal 300 transmits a first student's voice message of a first length at the first time and a second student terminal 300 transmits a second student's voice message of a second length that is shorter than the first length at the first time, then the receiving of the second student's voice message would be completed at the lesson room before the first student's voice message, and thus the matching manager 120 can assign a higher priority to the second student's voice message transmitted from the second student terminal 300 than to the first student's voice message transmitted from the first student terminal 300.

That is, in assigning an order of priority to the student's voice messages that have each been transmitted to the lesson room of the language instructor terminal 200, the matching manager 120 can assign higher priority to those student's voice messages for which longer times have passed since their transmission.

In another embodiment, the matching manager 120 can assign priority by utilizing the wait times since the student's voice messages arrived at the lesson room (Wait Time=Current Time−Message Arrival Time) and the sizes (or replay times) of the voice messages.

Here, the order of priority can be calculated by using an HRN (highest response-rate next) algorithm, where a specific example of an equation for calculating priority is presented below.

Priority=(Wait Time+Voice Message Replay Time)/(Voice Message Replay Time) [Equation 1]

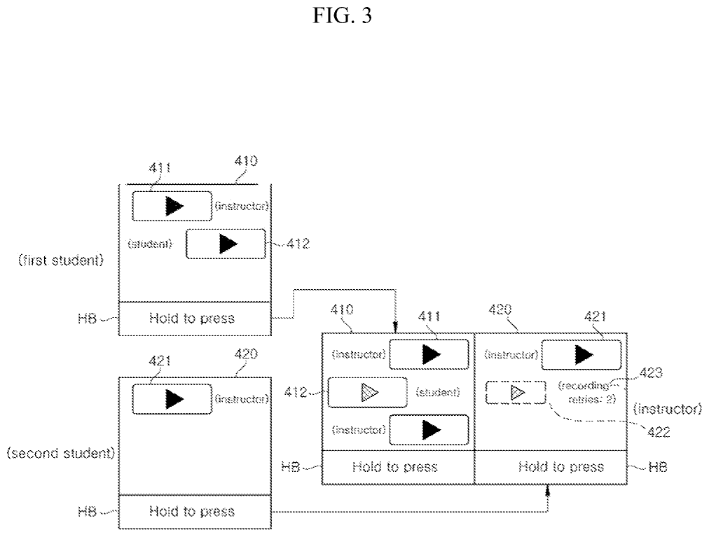

Referring to FIG. 3, the matching generator 110 can generate a first lesson room 410 in a first student terminal 300, generate a second lesson room 420 in a second student terminal 300, and generate the first lesson room 410 and second lesson room 420 in a language instructor terminal 200. The first and second lesson rooms 410, 420 can each include a voice record button, a voice replay button, a holding mode button (HB), and an assistant instructor connect button. The voice record button can be used when recording the user's voice, the voice replay button can be used when replaying the counterpart's voice, and the holding mode button (HB) can be used to temporarily switch to a holding state which may either automatically connect to an assistant instructor or temporarily switch to a holding state and generate the assistant instructor connect button that allows the user to attempt a connection to an assistant instructor.

When the holding mode button (HB) is pressed at a student terminal 300, the matching manager 120 can provide the language instructor terminal 200 with the information that the student has switched to a holding state, so that the instructor need not wait for the student and may reply first to a voice message of another student.

Also, when the holding mode button (HB) is pressed at the language instructor terminal 200, the matching manager 120 can provide the student terminals 300 with the information that the instructor has switched to a holding state, so that the students need not wait for the instructor and may either find another instructor if urgently needed or continue waiting for the instructor.

When an instructor's voice message 411 is recorded by way of the voice record button (not shown) in the first lesson room 410 of the language instructor terminal 200, the matching manager 120 transfers the instructor's voice message 411 to the first student terminal 300 to activate a lesson channel, and when a student's voice message 412 is recorded by way of the voice record button (not shown) in the first lesson room 410 of the first student terminal 300 in reply to the instructor's voice message 411, the matching manager 120 transfers the student's voice message 412 to the language instructor terminal 200 to activate a lesson channel.

Also, when an instructor's voice message 421 is recorded by way of the voice record button (not shown) in the second lesson room 420 of the language instructor terminal 200, the matching manager 120 can transfer the instructor's voice message 421 to the second student terminal 300 to activate a lesson channel, and when a student's voice message 422 is being recorded by way of the voice record button (not shown) in the second lesson room 420 of the second student terminal 300 in reply to the instructor's voice message 421, the matching manager 120 can provide the language instructor terminal 200 with information regarding the recording state 423. For example, the information regarding the recording state can include information on whether or not the student is recording, whether or not the voice recording has been completed, the number of retries made for the voice recording, the speed of the voice recording, etc. The speed of the voice recording can be used as basis data for modifying the speed of the voice message at the message editor 130.

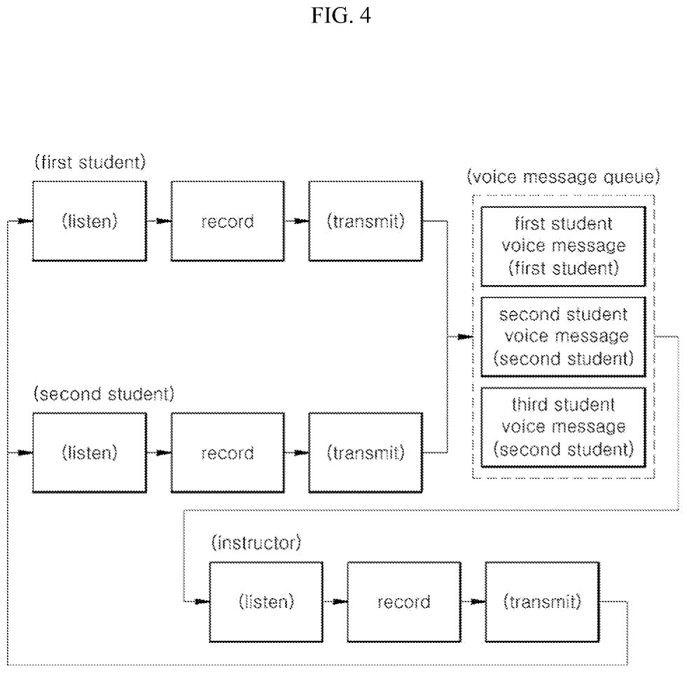

Referring to FIG. 4, the matching manager 120 can sequentially store student's voice messages transmitted from a first student and student's voice messages transmitted from a second student in a voice message queue. The matching manager 120 can manage the voice messages stored in the voice message queue to minimize the bottlenecking of voice messages stored in the voice queue, i.e., in a manner that allows the instructor to provide lessons simultaneously to as many students as possible.

For example, the matching manager 120 can provide a third student's voice message, which was stored first, to the language instructor terminal 200 via streaming and can subject a second student's voice message and first student's voice message, which were stored after the third student's voice message, to operations for removing silent segments or altering replay speeds by the message editor 130, so that the second student's voice message and the first student's voice message may be processed while the third student's voice message is provided, whereby, once the replaying of and the recording and transmitting a reply to the third student's voice message are completed, the replaying of and the recording and transmitting a reply to the second voice message may be performed immediately afterwards.

The matching manager 120 can assign higher priority to student's voice messages that have passed through the message editor 130 described below. Here, a student's voice message that has passed through the message editor 130 can be a message from which a silent segment has been deleted, and such messages having silent segments deleted can be assigned an order of priority based on the order in which the starting points or the ending points of the messages arrived at the lesson rooms.

The message editor 130 can analyze a student's voice message that has arrived at a lesson room to identify a silent segment and can delete the identified silent segment from the analyzed student's voice message. A silent segment can be identified as a portion of the voice message that does not contain a word.

The message editor 130 can edit a student's voice message by deleting an identified silent segment from the student's voice message and then connecting the voice segments preceding and succeeding the silent segment.

In one embodiment, the message editor 130 can modify the replay speed of a student's voice message or instructor's voice message. The replay speed of a voice message can be set by a student or the instructor.

In another embodiment, the message editor 130 can modify the student's voice messages to have higher speeds depending on the number of student's voice messages transferred to the language instructor terminal 200, so that the many student's voice messages may be replayed and replied to within a limited amount of time.

In yet another embodiment, the message editor 130 can divide each of the student's voice messages and instructor's voice messages into voice segments with respect to at least one word included in the message. A divided voice segment can be utilized to provide any one of a repeated reply, partial answer recording, partial side inquiry, and partial translation link for a particular voice segment.

When there is a request by a student, the repetitive learning unit 140 can provide a repetition of a requested instructor's voice message to the student who made the request. That is, the repetitive learning unit 140 can provide a repetition of an instructor's voice message or a student's voice message every time a voice replay button generated in the lesson room is pressed.

The side learning unit 150 can provide a list of available assistant instructors to a student or language instructor and, when there is a request from a student or a language instructor, can generate an inquiry channel between the student or language instructor and an assistant instructor. The list of assistant instructors can be generated according to the language of the nationality requested by the student or language instructor. The side learning unit 150 can allow side inquiries in voice, text, or image types.

The instructor list generator 160 can generate a list of valid instructors available for enrollment, based on the teaching schedules of the language instructors, the enrollment requests of students, and the number of messages per time for each language instructor, and can provide the list of valid instructors to students. The teaching schedule can be inputted by each language instructor via the language instructor terminal 200, the enrollment request can be inputted by each student via the student terminal 300, and the number of messages per time for each language instructor can be determined based on the average transmission speed of student's voice messages and the average reply speed of instructor's voice messages.

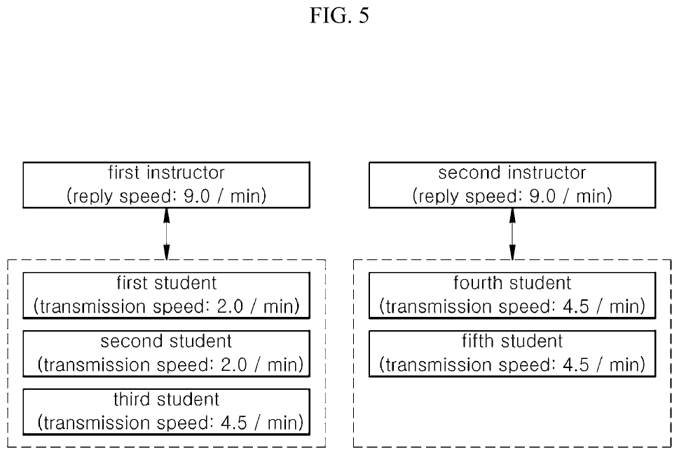

Referring to FIG. 5 in regard to the number of messages per time per language instructor, suppose, as an example, that a first student and a second student can transmit 2.0 voice messages per minute and a third student can transmit 4.5 voice messages per minute. Since a total of 8.5 voice messages can be transmitted in one minute, if a first instructor is capable of making 9.0 replies per minute, then the first instructor can teach all three of the first student, second student, and third student.

In another example, suppose that a fourth student and a fifth student can each transmit 4.5 voice messages per minute. Since a total of 9 voice messages can be transmitted in one minute, if a second instructor is capable of making 9.0 replies per minute, then the second instructor can teach both of the fourth student and the fifth student.

That is, the number of messages per time for each language instructor can be used for dynamically matching students with instructors based on the average message transmission speeds for multiple students participating in a lesson and the average message response speeds of the instructors.

The instructor list generator 160 can display the list such that a previously matched instructor, who has a history of a previous match with a student, or a similarly matched instructor, who has a lesson pattern similar to that of a previously matched instructor, is shown in a distinguished manner. The instructor list generator 160 can display previously matched instructors or similarly matched instructors with different marks of distinguishment in the list of valid instructors to allow a student to easily select a previously matched instructor or similarly matched instructor. For example, the instructor list generator 160 can highlight previously matched instructors in a first color and highlight similarly matched instructors in a second color in the list of valid instructors.

The controller 170 controls the overall operation of the relay server 100 for one-to-many matched language learning and controls the data flow between and operations of the matching generator 110, matching manager 120, message editor 130, repetitive learning unit 140, side learning unit 150, and instructor list generator 160.

### 2. Modes for Practice

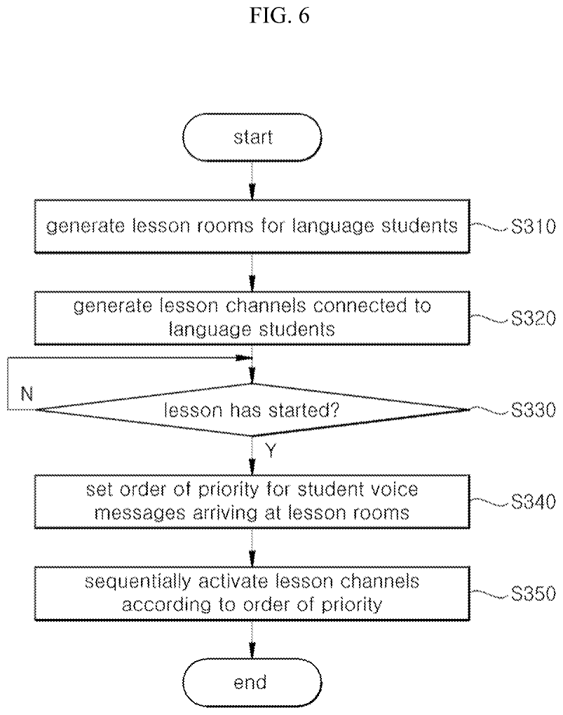

FIG. 6 is a flow diagram illustrating a method for one-to-many matched language teaching according to an embodiment of the present disclosure.

A method for one-to-many matched language teaching according to this embodiment is performed at a language-learning relay server and includes generating lesson rooms for multiple students (operation S310) and generating lesson channels with the multiple students through the lesson rooms (operation S320).

Afterwards, when a lesson begins with multiple student terminals 300, an order of priority is set according to a predetermined rule for student's voice messages arriving at the lesson rooms (operations S330 and S340).

A one-to-many matched language teaching process can further include analyzing a student's voice message that has arrived in the lesson room by way of the message editor 130 to identify a silent segment and deleting the identified silent segment from the analyzed student's voice message.

Here, setting the order of priority can involve assigning the order of priority by using at least one of an order in which the student's voice messages arrived at the lesson rooms, the replay times of the student's voice messages, the wait times of the student's voice messages in the lesson rooms, and the average replying times of the students or instructor, or can involve assigning priority to student's voice messages from which silent segments have been deleted.

Afterwards, the lesson channels of the messages can be activated sequentially according to the assigned order of priority (operation S350).

The one-to-many matched language teaching process can further include providing a student with a repetition of a requested instructor's voice message when the student makes such a request.

Also, the one-to-many matched language teaching process can further include activating one of multiple lesson channels in response to a selection made by the language instructor, to thereby allow the language instructor to personally select a lesson room regardless of the order of priority.

A method for one-to-many matched language teaching according to another embodiment of the present disclosure is proposed.

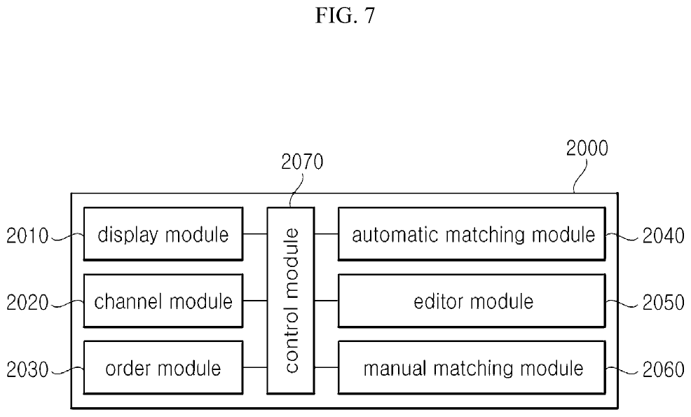

That is, another embodiment relates to a method of teaching a foreign language as performed from a language instructor terminal 2000, and FIG. 7 is a diagram showing a language instructor terminal for implementing the method for one-to-many matched language teaching according to another embodiment of the present disclosure.

In this embodiment, the language instructor terminal 2000 can include a display module 2010, a channel module 2020, an order module 2030, an automatic matching module 2040, and a control module 2070 and can further include an editor module 2050 and/or manual matching module 2060.

To be more specific, the method for one-to-many matched language teaching according to another embodiment includes an operation in which the display module 2010 displays a multiple number of students, an operation in which the channel module 2020 generates a lesson channel with each of the multiple students in a P2P (peer-to-peer) manner, an operation in which, once the lessons begin and student's voice messages arrive at the instructor terminal through the generated lesson channels, the order module 2030 sets an order of priority according to a predetermined rule for the messages that have arrived, and an operation in which the automatic matching module 2040 sequentially activates the lesson channels of the messages according to the set order of priority.

The order module 2030 assigns the order of priority by using at least one of the order in which the student's voice messages arrived at the terminal of the language instructor, the replay times of the student's voice messages, the wait times of the student's voice messages in the lesson rooms, and the average replying times of the students or instructor.

This embodiment can further include an operation in which an editor module 2050 analyzes a student's voice message that has arrived at the language instructor terminal 2000 to identify a silent segment and deletes the identified silent segment from the analyzed student's voice message. Here, the order module 2030 can assign an order of priority after the silent segments have been deleted from the student's voice messages.

This embodiment can further include an embodiment in which the manual matching module 2060 receives an input of a selection made by the language instructor and activates the selected channel from among the multiple number of lesson channels.

Incidentally, the control module 2070 controls the data flow between and operations of the display module 2010, channel module 2020, order module 2030, automatic matching module 2040, editor module 2050, and manual matching module 2060.

Those of ordinary skill in the art would readily understand that all or some of the functions of the method for teaching a language according to the embodiments described above can also be implemented in a tangible form as a computer-readable recorded medium including a program of instructions for performing such functions.

Such a computer-readable medium can include program instructions, data files, data structures, etc., alone or in combination. The program instructions recorded on the computer-readable medium can be designed and configured specifically for the present disclosure or can be a type of medium known to and used by the person skilled in the field of computer software.

Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, USB memory, etc., configured specially for storing and executing program instructions.

The computer-readable medium can also be a transmission medium such as rays, metal wires, waveguides, etc., which may include carrier waves for transferring signals that signify program instructions, data structures, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the present disclosure, and vice versa.

Furthermore, it is to be appreciated that the present disclosure is not limited to the embodiments described above, the present disclosure can have a varied scope of application, and numerous variations can be made without departing from the essence of the present disclosure as defined in the scope of claims.

What is claimed is:

1. A relay server for one-to-many matched language learning that connects one language instructor with a plurality of students, the relay server comprising:
a matching generator configured to generate a lesson room for connecting a plurality of students and a language instructor and generate a lesson channel between each of the students and the language instructor who have accessed the lesson room; and
a matching manager configured to set an order of priority according to a predetermined rule for student's voice messages that have arrived at the lesson room and sequentially activate the lesson channels of the messages according to the set order of priority, when a lesson begins.

2. The relay server for one-to-many matched language learning according to claim 1, wherein the matching manager assigns the order of priority by using at least one of an order in which the student's voice messages arrived at the lesson room, replay times of the student's voice messages, wait times of the student's voice messages in the lesson room, and average replying times of the students or instructor.

3. The relay server for one-to-many matched language learning according to claim 1, further comprising:
a message editor configured to analyze a student's voice message that has arrived at the lesson room to identify a silent segment and delete the identified silent segment from the analyzed student's voice message.

4. The relay server for one-to-many matched language learning according to claim 3, wherein the matching manager assigns priority to student's voice messages that have passed through the message editor.

5. The relay server for one-to-many matched language learning according to claim 1, further comprising:
a side learning unit configured to:
provide a list of available assistant instructors to a student, and
generate an inquiry channel, upon request by the student, between the student and an assistant instructor for making an inquiry in a native language of the student.

6. The relay server for one-to-many matched language learning according to claim 1, further comprising:
an instructor list generator configured to generate a list of valid instructors available for enrollment and provide the list of valid instructors to a student, the list of valid instructors generated based on teaching schedules of language instructors, enrollment requests of students, and a number of messages per time for each language instructor.

7. The relay server for one-to-many matched language learning according to claim 6, wherein the instructor list generator displays a previously matched instructor having a history of a previous match with the student or a similarly matched instructor having a lesson pattern similar to that of the previously matched instructor in a manner differentiated from other instructors in the list.

8. A method for one-to-many matched language teaching, the method performed at a language instructor terminal, the method comprising:
displaying a plurality of students, the displaying performed by a display module;
generating a lesson channel with each of the plurality of students in a P2P (peer-to-peer) manner, the generating performed by a channel module;
setting an order of priority for student's voice messages according to a predetermined rule, when the student's voice messages arrive at the language instructor terminal through the generated lesson channels, the setting performed by an order module; and
sequentially activating the lesson channels of the student's voice messages according to the set order of priority, the activating performed by an automatic matching module.

9. The method for one-to-many matched language teaching according to claim 8, wherein the setting of the order of priority comprises assigning the order of priority by using at least one of an order in which the student's voice messages arrived at the terminal of the language instructor, replay times of the student's voice messages, wait times of the student's voice messages at the language instructor terminal, and average replying times of the students or instructor.

10. The method for one-to-many matched language teaching according to claim 8, further comprising:
analyzing a student's voice message that has arrived at the language instructor terminal to identify a silent segment and deleting the identified silent segment from the analyzed student's voice message.

11. The method for one-to-many matched language teaching according to claim 10, wherein the setting of the order of priority comprises assigning priority to student's voice messages from which the silent segments have been deleted.

12. The method for one-to-many matched language teaching according to claim 8, further comprising:
activating one of the plural lesson channels according to a selection made by the language instructor.
